(19) United States
(12) Patent Application Publication
(10) Pub. No.: US 2008/0122365 A1
(43) Pub. Date: May 29, 2008

(54) Method of Supplying Pulsed Power to Light Bulbs in Motor Vehicles

(75) Inventors: Nikolaus Decius, Lippstadt (DE); Martin Schumacher, Oelde (DE)

Correspondence Address: HUSCH BLACKWELL SANDERS LLP, 190 CARONDELET PLAZA, SUITE 600, ST. LOUIS, MO, 63105-3441, US

(73) Assignee: Hella KGaA, Lippstadt (DE)

(21) Appl. No.: 11/933,614

(22) Filed: Nov. 1, 2007

(30) Foreign Application Priority Data
Nov. 24, 2006 (DE) DE 102006055610.0

(51) Int. Cl. B60Q 1/14

(52) U.S. Cl. 315/77

(57) ABSTRACT

This application document describes a method of supplying pulsed power to light bulbs of different output ratings in motor vehicles. The pulse width (duty cycle: ratio of pulse duration and period duration) is adjustable by detecting the bulb current (I), determining the nominal output of the light bulb that power is to be supplied to, and adapting the pulse width to the bulb current (I) detected.

### CROSS-REFERENCE TO RELATED APPLICATIONS

This application claims priority to international application DE 10 2006 055 610.0 filed Nov. 24, 2006.

### BACKGROUND OF THE INVENTION

### Field of the Invention

The invention is about a method of supplying pulsed power to light bulbs in motor vehicles. The pulse width (duty cycle: ratio of pulse duration and period duration) is adjustable. One example of how light bulbs can be dimmed by means of pulse width modulation (PWM) is described in DE 103 04 636 A1 where it is explained that the voltage of bulbs operated in PWM mode can be dimmed down from excessive voltages on the vehicle's on-board mains to an uncritical effective value. Furthermore, EP 1 309 231 131 shows that bulbs designed for operation on 12V mains can be run on 42V mains if PWM dimming is in place.

The light bulbs are supplied with pulsed power via semiconductor switches residing in dimmer control devices. A vehicle may host one or several dimmer control devices for actuating the light bulbs of vehicle lamps and headlamps. The dimmer control devices are installed in remote places away from the vehicle lamps and headlamps.

An important factor to be considered if destruction of or damage to the semiconductor switches is to be avoided is that the semiconductor switches, and their chip surface in particular, must be adapted to the nominal output of the bulbs to be supplied with power.

European manufacturers use light bulbs with a nominal output of 21 W for certain lighting functions (e.g. indicator light, stop light, rear fog light, etc.). In the US, light bulbs used for these functions may have a nominal output of either 21 watts or 27 watts. However, everyday commercial life in the US mainly finds 27 W bulbs for the aforementioned functions. Since at least some of the vehicles manufactured entirely or primarily for the European market are also exported to the US, their semiconductor switches are designed to also supply power to 27 W bulbs because garages in the US will normally replace broken 21 W bulbs with the 27 W bulb according to US market standards.

Consequently, the semiconductor switches of the vast majority of vehicles not run in the US are actually oversized because only the 21 W variety of bulbs will be installed. Due to the fact that a dimmer control device contains a large number of semiconductor switches for supplying power to the different light bulbs, their oversized switches will cause a substantial increase in costs. Moreover, due to their larger chip surface, the oversized semiconductor switches will require an unfavorably larger amount of space.

### SUMMARY OF THE INVENTION

The present invention aims at avoiding oversized semiconductor switches while maintaining their compatibility with differently rated light bulbs.

According to the invention, the method of supplying pulsed power to light bulbs of different output ratings based on an adjustable pulse width (duty cycle: ratio of pulse duration and period duration) consists of detecting the bulb current (I) to recognize the nominal output of the light bulb that power is to be supplied to. Assuming the onboard mains voltage is known (bulb supply voltage) it can be combined with the bulb current to compute the bulb's nominal output (P=U×I). The next step is to adapt the pulse width to the detected bulb current (I), that is to say, knowledge of the nominal output of the light bulb that power is to be supplied to is taken to adjust the pulse width accordingly.

This method allows the use of semiconductor switches rated for the supply of power to light bulbs of a specific nominal output (e.g., 21 W) while still maintaining the possibility of continuously and reliably operating light bulbs of a higher nominal output (e.g., 27 W).

A 27 W bulb that may be used will be recognized by detecting the bulb current as being different from that of a 21 W bulb. Pulse width modulation (PWM) will then be applied to adapt, i.e. reduce, the pulse width accordingly. This way a semiconductor switch designed for 21 W bulbs will not be destroyed by high temperature if it supplies pulsed power to a 27 W bulb. PWM dimming of the power supply to 27 W bulbs still stays within the admissible range of technical lighting requirements.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The figures attached hereto are taken to further explain the invention. The following is shown:

FIG. 1 is a schematic diagram of the circuitry required to put the method into practice.

FIG. 2 is a diagram illustrating pulse width modulation for different light bulbs and different voltages of vehicles' on-board mains.

### DETAILED DESCRIPTION OF THE PREFERRED EMBODIMENTS

The following description of the preferred embodiment(s) is merely exemplary in nature and is in no way intended to limit the invention, its application, or uses.

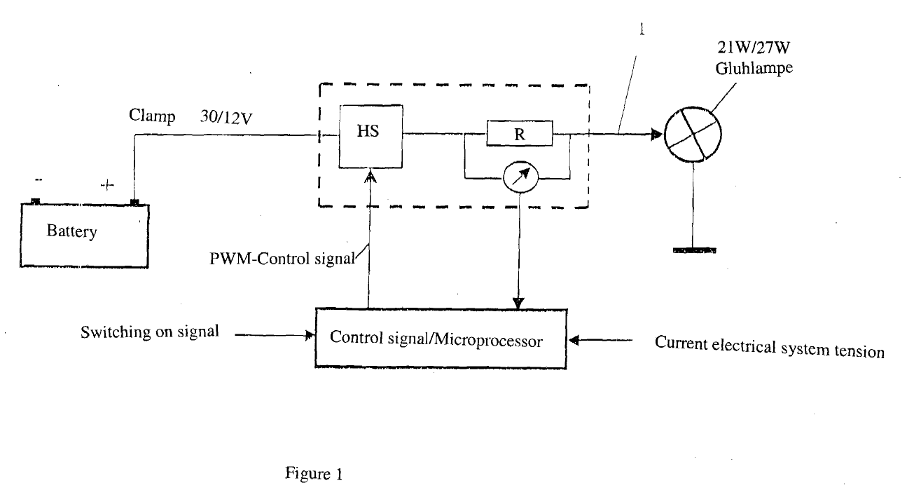

FIG. 1 is the schematic diagram of the circuitry required to supply pulsed power to light bulbs of different nominal output ratings (e.g. 21 watts or 27 watts). Supply of electrical power (current and voltage) is provided by the bulb shown in the example being attached to the positive pole of the vehicle's battery via so-called terminal 30. A semiconductor switch (SCS), preferably a low-loss MOSFET, is added to the circuit between the battery and the light bulb. To obtain a pulsed power supply to the light bulb the semiconductor switch will make and break contact with the light bulb at a clock cycle set by a control unit (e.g. a microprocessor). The control unit will not only set the clock cycle or the clock pulse rate (period duration) but also the pulse width (also referred to as duty cycle), that is to say, the ratio of pulse duration and period duration. To protect the light bulb and semiconductor switch (SCS) against the effects of high mains voltages, this pulse width modulation (PWM) can be used to dim the bulb voltage to an effective value of 12 V, for example. This is achieved by feeding the control unit the on-board mains voltage as one of its input variables.

According to the invention, the method comprises a detection of the bulb current (I) which allows a determination of the nominal output of the bulb to be supplied with power.

This piece of information is also transferred to the control unit which uses it to adapt the pulse width to the nominal output of the bulb to be supplied with power.

The described circuitry preferably has separate default effective voltage settings for at least two light bulbs of different nominal output ratings, and pulse width adjustment dims the bulb voltage to the correct effective voltage. When a light bulb of a nominal output of 21 W is detected the effective voltage will be set to 12 V if the on-board mains is also a 12 V network. As long as there is no higher voltage on the mains the pulse width (duty cycle) will then be 100%. When a light bulb of a nominal output of 27 W (at 12 V) is detected, pulse width modulation will dim the bulb voltage to an effective voltage lower than 12 V. The target effective voltage to be set in this case is the same as the voltage to be fed to a resistive consumer with an ohmic resistance of (R_{27W}) of a 27 W light bulb if an output of 21 W is to be obtained:

R_{27W}=(12V)²/27 W=5.33Ω

U_{Eff.}=\sqrt{21 W×5.33Ω}=10.58V

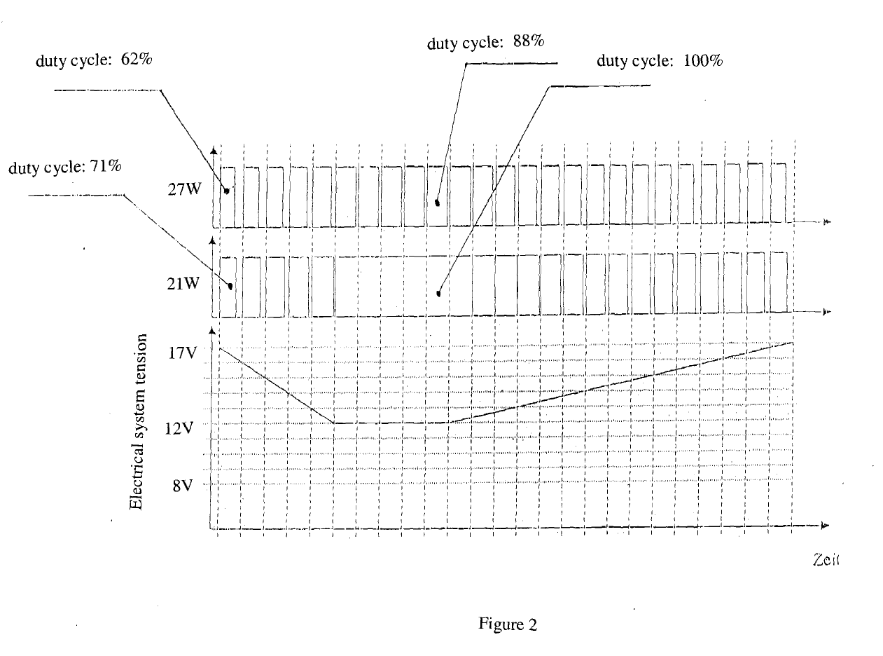

Consequently, when a light bulb of a nominal output of 27 W is detected the effective voltage will be set to 10.58 V if the on-board mains is a 12 V network. As long as there is no higher voltage on the mains the pulse width (duty cycle) will then be 88% (see FIG. 2). This way the unwanted thermal power loss in the semiconductor switch no longer depends on whether a light bulb of a nominal output of 21 W or a nominal output of 27 W is operated.

To measure the bulb current (I), the power supply circuit of the light bulb contains a measuring resistor (R) the voltage drop across which is taken as the variable value which is transferred to the control unit for computing the bulb current (I).

A particularly advantageous embodiment of the invention uses a semiconductor switch (SCS) with an integrated current measuring circuit. This type of semiconductor switch (SCS) with an integrated measuring resistor (also referred to as a sense) is considerably more cost-efficient than working with a separate measuring resistor.

The bulb current is preferably detected during a detection phase immediately after turning on the light bulb but after the so-called cold start current surge is over. One embodiment suggests to always set the pulse width to the 21 W bulb whenever the bulb is turned on. If a 27 W bulb is detected during the detection phase, the pulse width will then be adjusted accordingly.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A method of supplying pulsed power to light bulbs of different output ratings in motor vehicles, where the pulse width is adjustable, comprising:
detecting the bulb current (I) to recognize the nominal output of the light bulb to be supplied with power; and
adjusting the pulse width dependent on the bulb current (I) detected.

2. The method of claim 1, characterized by the bulb current (I) being detected during a detection phase immediately after turning on the light bulb but preferably after the cold start current surge is over.

3. The method of claim 1, characterized by the pulse width additionally being adjusted dependent on the value of the on-board mains voltage supplied to the light bulb.

4. The method of claim 1, characterized by a separate default effective voltage being defined for at least two light bulbs of different nominal output ratings, pulse with dimming adjusting the bulb voltage to the correct effective voltage.

5. The method of claim 1, characterized by a semiconductor switch, preferably a MOSFET, being used to generate the pulsed power.

6. The method of claim 1, characterized by a measuring resistor (R) being included to detect the bulb current (I), where the voltage drop across the measuring resistor (R) is the variable value taken to compute the bulb current (I) for pulse width adjustment.

7. The method of claim 5, characterized by the semiconductor switch (SCS) having an integrated current measuring circuit.

8. The method of claim 5, characterized by the information about the detected bulb current (I) being transferred to a control unit, the control unit generating a signal controlling the pulsed operation of the semiconductor switch, wherein the control unit uses the bulb current (I) to adjust the pulse width.
